(19) United States
(12) Patent Application Publication
(10) Pub. No.: US 2011/0037674 A1
(43) Pub. Date: Feb. 17, 2011

(54) OFFSET PARABOLA ANTENNA

(75) Inventors: Hiroshi Matsubara, Aichi (JP); Chikahiko Nakane, Aichi (JP)

Correspondence Address: INTELLECTUAL PROPERTY / TECHNOLOGY LAW, PO BOX 14329, RESEARCH TRIANGLE PARK, NC, 27709, US

(73) Assignee: MASPRODENKOH KABUSHIKIKAISHA, Aichi (JP)

(21) Appl. No.: 12/988,578

(22) PCT Filed: Apr. 23, 2009
(86) PCT No.: PCT/JP09/58076

§ 371 Date: Oct. 19, 2010

(30) Foreign Application Priority Data
Apr. 23, 2008 (JP) 2008-113020

(51) Int. Cl. H01Q 19/13

(52) U.S. Cl. 343/840

(57) ABSTRACT

An offset parabola antenna includes an elliptical parabolic reflector having a mirror surface in a shape partially cut out from a paraboloid, a primary radiator, and a supporting arm which supports the primary radiator to fix the primary radiator at a focal point of the parabolic reflector. The primary radiator is fixed to the supporting arm such than a beam central axis, at which a received electric power is maximized within a directional range of the primary radiator, is directed to a substantially middle position between a central point of an aperture plane of the parabolic reflector and a central point of an aperture angle of the parabolic reflector.

### TECHNICAL FIELD

The present invention relates to a parabola antenna which is mainly used to receive microwaves. In particular, the present invention relates to an offset parabola antenna which is suitable for receiving satellite broadcasts and has an especially preferred antenna gain to noise temperature ratio (G/T).

### BACKGROUND ART

Generally, a parabolic reflector constituting an offset parabola antenna is configured from a portion, offset from a rotational axis of a paraboloid, which is cut out in such a manner that an aperture plane has a circular shape when viewed from an arrival direction of electric waves. At a position of a focal point of the parabolic reflector, a primary radiator is disposed via a supporting arm fixed to the parabolic reflector.

The primary radiator generally has the highest sensitivity in relation to electric waves from a central direction of a directional range. With regard to reflection waves from the parabolic reflector, reflection waves from a central point of the aperture plane have the highest level of signals.

In view of the above, in the offset parabola antenna, the primary radiator is generally disposed as follows: a central axis (i.e., generally, an axis line in a direction where a received electric power is maximized) of the directional range is directed to a point (hereinafter, referred to as a central point of an aperture plane). The central point of the aperture plane is a point at which an axis line, passing through a center of the aperture plane when the parabolic reflector is viewed from an arrival direction of electric waves (specifically, an arrival direction of electric waves to be collected at a position of a focal point of the parabolic reflector), points to the parabolic reflector.

In other words, conventionally, the primary radiator is disposed in relation to the parabolic reflector such that a beam central axis of the primary radiator is directed to the central point of the aperture plane of the parabolic reflector, thereby achieving high receiving efficiency of reflection waves from the parabolic reflector to improve antenna gain.

Depending on directional performance of the primary radiator, however, a phenomenon (a so-called spillover) may occur, for example, in which some of electric waves coming from behind the parabolic reflector are not shielded by the parabolic reflector and thus, are directly incident on the primary radiator. This spillover is a cause of reception noise. Thus, there is a problem in which as the spillover increases, the reception noise increases, thereby affecting reception performance.

That is, for example, in order to improve antenna gain, the primary radiator is configured such that a size of the directional range, which is one of the directional performance of the primary radiator, is substantially equal to an aperture angle (specifically, an angle formed by an upper edge and a lower edge of the parabolic reflector when viewed from the focal point) of the parabolic reflector. Then, the primary radiator is disposed as above in relation to the parabolic reflector. In this case, a portion in the vicinity of an outermost border in the directional range of the primary radiator goes beyond the upper edge of the parabolic reflector. Consequently, the above-mentioned spillover occurs, resulting in degradation of the reception performance of the offset parabola antenna.

The reason why the spillover occurs when the primary radiator is disposed as above is as follows. A position of the central point of the aperture plane of the parabolic reflector is different from a position of a point (hereinafter, referred to as a central point of the aperture angle) where a bisector, which bisects an aperture angle formed by two lines respectively connecting both ends of the parabolic reflector in a long-diameter direction and the focal point of the parabolic reflector, points on the parabolic reflector. Thus, in the parabolic reflector which is offset upwards, the central point of the aperture plane is located higher than the central point of the aperture angle.

As shown in FIGS. 8A and 8B, in the offset parabola antenna, a line connecting the central point O of the aperture plane of the parabolic reflector and the focal point F is defined as OF, a line connecting the lower edge A of the parabolic reflector and the focal point F is defined as AF, and a line connecting the upper edge B of the parabolic reflector and the focal point F is defined as BF. In this case, an angle β formed by the line OF and the line BF is smaller than an angle α formed by the line OF and the line AF. Accordingly, the central point P of the aperture angle indicated by the line FP bisecting the aperture angle BFA is located lower than the central point O of the aperture plane.

Accordingly, as mentioned above, the directional range of the primary radiator is designed to be equal to the aperture angle (i.e., the angle BFA) of the parabolic reflector. Then, an axial line in a direction where a received electric power is maximized within the directional range of the primary radiator is directed to the central point O of the aperture plane. In this case, a portion in the vicinity of the outer border of the directional range goes beyond the upper edge of the parabolic reflector. Therefore, although the antenna gain can be improved, there would be a problem in which the antenna is subject to be affected by reception noise due to spillover.

An overall performance of a satellite antenna is determined by an antenna gain to noise temperature ratio (G/T) which represents a ratio between antenna gain and noise. The higher the ratio is, the better the performance is. Because of a recent improvement of characteristics of a high-frequency amplifying element, such as HEMT (High Electron Mobility Transistor), a converter having a small noise figure has been provided. Under such circumstances, in order to provide an antenna having an excellent antenna gain to noise temperature ratio (G/T), it has been requested, not only to improve antenna gain, but also to reduce influence of reception noise due to the above-explained spillover.

In order to respond to the request, the following method can be considered. That is, the primary radiator is fixed such that the directional range of the primary radiator is made to be substantially equal to the aperture angle (i.e., the angle BFA) of the parabolic reflector, and further, an angle formed by a central axis of the directional range (i.e., a beam central axis) of the primary radiator and the line AF is made to be equal to an angle formed by the beam central axis of the primary radiator and the line BF.

In other words, the beam central axis of the primary radiator is arranged to direct to the central point P of the aperture angle of the parabolic reflector. Although this method achieves reducing the spillover, the following problem may be experienced. That is, since a brightness distribution of directionality of the primary radiator at the upper and lower edges of the parabolic reflector is not uniform, it is not possible to efficiently use reflection waves from the reflector. Thus, the reception gain may be degraded.

In order to deal with these problems, the following configuration is conventionally suggested. That is, as shown in FIGS. 8A and 8B, in a projection image formed when the aperture plane of the parabolic reflector is projected onto an XY plane, a length L in a direction oblique to an X direction and a Y direction is set longer than a length r in the X direction and the Y direction, so that the projection image has a substantially rectangular shape. With this configuration, the spillover can be reduced without increasing a long-diameter dimension and a short-diameter dimension of the parabolic reflector.

Also, the following configuration is conventionally suggested. As shown in FIGS. 9A and 9B, the length in the X direction of the projection image, having a substantially rectangular shape, of the above-mentioned parabolic reflector on the XY plane is set longer than the length in the Y direction of the projection image. Thereby, the reception gain can be improved without increasing the short-diameter dimension (see, for example, Patent Literature 1).

### PRIOR ART LITERATURE

### Patent Literature

Patent Literature 1: Unexamined Japanese Patent Application Publication No. H11-103214

### DISCLOSURE OF THE INVENTION

### Problems to be Solved by the Invention

The above proposed offset parabola antenna makes it possible to reduce spillover without increasing the short-diameter dimension (generally, a length representing a size of an antenna) of the parabolic reflector by configuring the parabolic reflector to have a substantially rectangular shape. However, since an area itself of the parabolic reflector becomes larger, following problems are found.

Such problem are, due to the enlarged area of the parabolic reflector, the above proposed offset parabola antenna has a heavier weight and a larger wind-receiving area than a generally commercially available antenna with the same short-diameter dimension.

Accordingly, it becomes necessary to strengthen an antenna support member and an attachment bracket, thereby causing a problem of increasing costs for the offset parabola antenna. Furthermore, from a user's point of view, there is a problem in which when the antenna is attached to an attachment object, such as a roof or a balcony, the user's operability of the attachment is decreased.

In addition, the above proposed offset parabola antenna has a problem in which the parabolic reflector has not a generally oval shape but a unique shape. Thus, it is necessary to newly make a mold for manufacturing the reflector in order to reduce spillover, thereby causing increase in cost.

Moreover, as in the offset parabola antenna shown in

FIGS. 9A and 9B, the upper edge of the parabolic reflector is extended to a point C higher than a normal position of the upper edge B. Then, the central axis of the directional range of the primary radiator is directed to a point O (central point of an aperture plane of the parabolic reflector before extending upwards) while maintaining a conventional directional range (angle BFA) of the primary radiator. In this case, with the extended portion C, it is possible to realize reduction of spillover and improvement of gain; however, it cannot be said that the overall parabolic reflector including the enlarged area is effectively used.

In this regard, the following method is considered; the directional range of the primary radiator is expanded to an angle CFA so as to be equal to an aperture angle of a newly formed parabolic reflector having a substantially rectangular shape, and then the central axis of the directional range of the primary radiator is arranged to direct the above-mentioned point O. However, this point O is also the central point of the aperture angle of the new parabolic reflector. Thus, although reduction of the spillover can be expected, further improvement of the gain cannot be expected since advantage of the expanded parabolic reflector cannot be fully utilized.

Moreover, it is also considered that the directional range of the primary radiator is expanded to the angle CFA so as to be equal to the aperture angle of the newly formed parabolic reflector having the substantially rectangular shape. Then, the central axis of the directional range of the primary radiator is arranged to direct a new central point Q of an aperture angle, which is located above the point O, of the newly formed parabolic reflector having the substantially rectangular shape. In this case, by fully utilizing the advantage of the expanded parabolic reflector, further improvement of the reception gain may be expected. However, as in the case of the above problem, the spillover may occur again.

That is to say, in the above proposed technique, an apparent size of the offset parabola antenna is not increased by maintaining at least a short-diameter dimension of the parabolic reflector. However, the area itself of the parabolic reflector is increased to reduce the spillover. As above, it has not been considered to use the parabolic reflector as efficient as possible.

The present invention has been made in view of the above problems. An object of the present invention is to provide an offset parabola antenna with which spillover can be reduced without increasing an area of a parabolic reflector in relation to a directional range of a primary radiator.

### Means for Solving the Problems

According to a first aspect of the present invention to achieve the above object, there is provided an offset parabola antenna which includes an elliptical parabolic reflector having a mirror surface in a shape partially cut out from a paraboloid, a primary radiator; and a supporting arm which supports the primary radiator to fix the primary radiator at a focal point forward of the mirror surface of the parabolic reflector. The primary radiator is fixed to the supporting arm such that a beam central axis, at which a received electric power is maximized within a directional range of the primary radiator, is directed to a substantially middle position between a central point of an aperture plane of the parabolic reflector and a central point of an aperture angle of the parabolic reflector. The central point of the aperture plane is a point, on the mirror surface of the parabolic reflector, which is indicated by an axial line passing through a center of the aperture plane when the parabolic reflector is viewed from an arrival direction of electric waves to be collected at the focal point of the parabolic reflector. The central point of the aperture angle is a point, on the mirror surface of the parabolic reflector, which is indicated by a bisector bisecting an aperture angle formed by two lines respectively connecting both ends of the parabolic reflector in a long-diameter direction and the focal point of the parabolic reflector.

A second aspect of the present invention is that, in the offset parabola antenna according to the first aspect, a directional performance of the primary radiator is configured such that the directional range is substantially equal to the aperture angle of the parabolic reflector, and directional characteristics are such that a received electric power at a border of and outside of the directional range is lower by a set value than a maximum received electric power within the directional range.

### Effect of the Invention

In the first aspect of the offset parabola antenna according to the present invention, the primary radiator is fixed to the supporting arm such that the beam central axis of the primary radiator is directed to the substantially middle position between the central point of the aperture plane of the parabolic reflector and the central point of the aperture angle of the parabolic reflector.

Thus, the offset parabola antenna according to the present invention makes it possible to reduce spillover, in which unnecessary electric waves are directly incident on the primary radiator, without increasing an area of the parabolic reflector than that of a normal parabolic reflector as in the case of the back ground art shown in FIGS. 8A and 8B, and FIGS. 9A and 9B. Thus, it is possible to improve use efficiency of the parabolic reflector. Moreover, since the spillover can be reduced, it is possible to improve an antenna gain to noise temperature ratio (G/T) of the offset parabola antenna.

The offset parabola antenna according to the present invention can improve the antenna gain to noise temperature ratio (G/T) by simply directing the central axis (beam central axis) of the directional range of the primary radiator to the substantially middle position between the central point of the aperture plane of the parabolic reflector and the central point of the aperture angle of the parabolic reflector. Therefore, it is possible to improve the antenna characteristics easily and at low cost even with existing offset parabola antennas.

Also, the offset parabola antenna according to the present invention can be constituted without changing size and weight of a conventional parabolic reflector. Therefore, usability for users, such as operability when attaching an antenna, will not be degraded.

Next, in a second aspect of the offset parabola antenna, among directional performance of the primary radiator, the directional range is configured to be substantially equal to the aperture angle of the parabolic reflector. Moreover, the directional characteristics are configured such that the received electric power at a border of and outside of the directional range is lower by at least a set value than a maximum received electric power which the primary radiator receives. Thus, reduction of spillover is ensured, thereby reducing reception noise. As a result, an antenna gain to noise temperature ratio (G/T) of the offset parabola antenna can be increased.

For the purpose of reducing reception noise as above to increase an antenna gain to noise temperature ratio (G/T), the above set value may be set within a range of 10 dB to 15 dB (more preferably, 15 dB), as described in a later explained embodiment.

### BRIEF DESCRIPTION OF THE DRAWINGS

FIGS. 1A and 1B are explanatory views showing a configuration of an offset parabola antenna according to an embodiment. FIG. 1A is a perspective view of the overall configuration of the offset parabola antenna. FIG. 1B is a side view showing a primary radiator.

FIGS. 2A and 2B are partly broken-out side views showing a configuration of a connecting section between the primary radiator and a supporting arm. FIG. 2A shows a state of the primary radiator and the supporting arm before connected. FIG. 2B shows a state of the primary radiator and the supporting arm after connected.

FIGS. 3A and 3B are explanatory views showing a normal positional relationship between a parabolic reflector and the primary radiator. FIG. 3A is a cross sectional view of the parabolic reflector vertically taken in an XZ plane. FIG. 3B is a projection view of the parabolic reflector in an XY plane, when viewed from an arrival direction of electric waves to be collected at a focal point of the parabolic reflector.

FIG. 4 is a characteristic diagram illustrating a directional performance of the primary radiator which constitutes the offset parabola antenna according to the embodiment.

FIGS. 5A and 5B are explanatory views to illustrate spillover which occurs in the normal positional relationship shown in FIGS. 3A and 3B. FIG. 5A is a cross sectional view of the parabolic reflector in the XZ plane. FIG. 5B is a projection view of the parabolic reflector projected onto the XY plane.

FIGS. 6A and 6B are explanatory views showing a positional relationship between the parabolic reflector and the primary radiator according to the embodiment. FIG. 6A is a cross sectional view of the parabolic reflector in the XZ plane. FIG. 6B is a projection view of the parabolic reflector projected onto the XY plane.

FIG. 7 is a graph which illustrates electrical properties of the offset parabola antenna according to the embodiment.

FIGS. 8A and 8B are explanatory views showing a shape of a conventional parabolic reflector and a positional relationship between the conventional parabolic reflector and a primary radiator. FIG. 8A is a cross sectional view of the parabolic reflector in the XZ plane. FIG. 8B is a projection view of the parabolic reflector projected onto the XY plane.

FIGS. 9A and 9B are explanatory views showing another shape of the conventional parabolic reflector and a positional relationship between the conventional parabolic reflector and the primary radiator. FIG. 9A is a cross sectional view of the parabolic reflector in the XZ plane. FIG. 9B is a projection view of the parabolic reflector projected onto the XY plane.

### EXPLANATION OF REFERENCE NUMERALS

1 . . . parabolic reflector, 2 . . . projection view of aperture plane, 3 . . . projection view of directional range, 5,7 . . . extending portion, 6,8 . . . inside portion, A . . . lower edge of parabolic reflector, B . . . upper edge of parabolic reflector, F . . . focal point, O . . . central point of aperture plane, P . . . central point of aperture angle, R . . . origin of performance, 10 . . . supporting arm, 20 . . . primary radiator, 22 . . . horn, 24 . . . case portion, 25 . . . output terminal, 26 . . . body portion, 28 . . . synthetic resin case, 29 . . . fixing portion.

### BEST MODE FOR CARRYING OUT THE INVENTION

Hereinafter, an embodiment of the present invention will be described with reference to drawings.

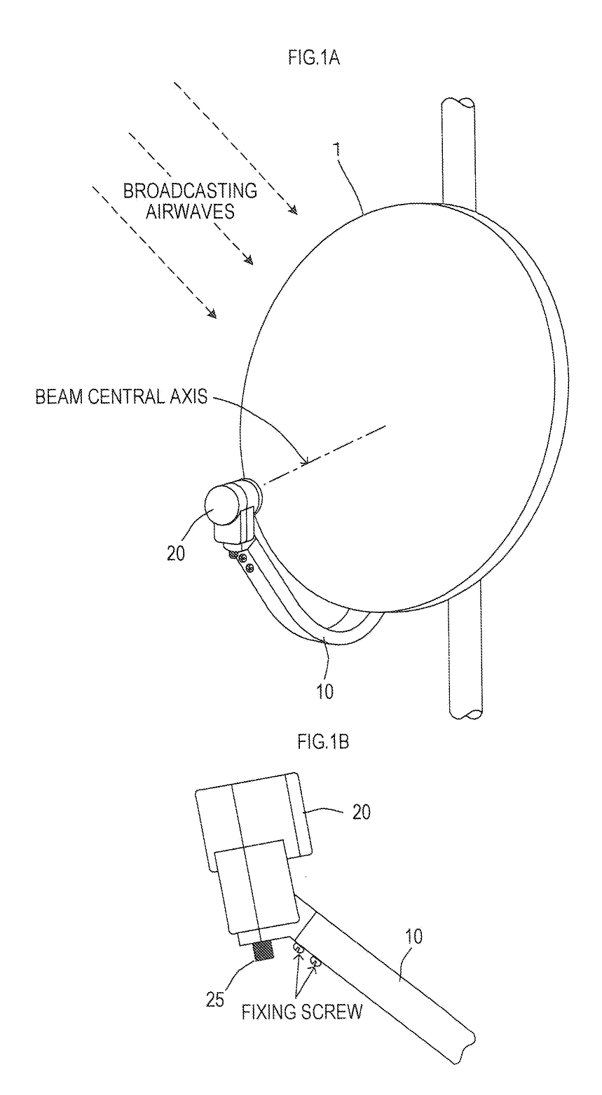

An offset parabola antenna according to the present embodiment is an antenna for receiving satellite broadcasts which receives broadcasting airwaves transmitted from a geostationary satellite, and converts received signals to a predetermined intermediate frequency band to output to a terminal side. As shown in FIGS. 1A and 1B, the offset parabola antenna includes an elliptical parabolic reflector 1, a supporting arm 10, and a primary radiator 20. The parabolic reflector 1 has a mirror surface in a shape partially cut out from a paraboloid. The supporting arm 10 has one end fixed to a back side of the parabolic reflector 1, and the other end extending to a vicinity of a focal point of a front face (mirror surface) in the parabolic reflector 1. The primary radiator 20 is fixed to the other end of the supporting arm 10 so as to be fixed to a position of the focal point of the parabolic reflector 1.

The parabolic reflector 1 has a known configuration: that is, the mirror surface (front face) of the parabolic reflector 1 is directed towards a geostationary satellite transmitting broadcasting airwaves, and is fixed to a pole and the like arranged in a vertical direction with a fixing clamp (not shown) provided at the back side of the parabolic reflector 1; therefore, the broadcasting airwaves from the geostationary satellite can be reflected by the front face (mirror surface); accordingly, the broadcasting airwaves can be collected at the position of the focal point in the mirror surface.

The primary radiator 20 includes a converter circuit. The converter circuit is configured to down-convert a received signal (having several tens of GHz) of the electric waves collected by the parabolic reflector 1, into an intermediate frequency signal having a frequency of several GHz. From the primary radiator 20, the intermediate frequency signal after the down conversion is outputted as the received signal.

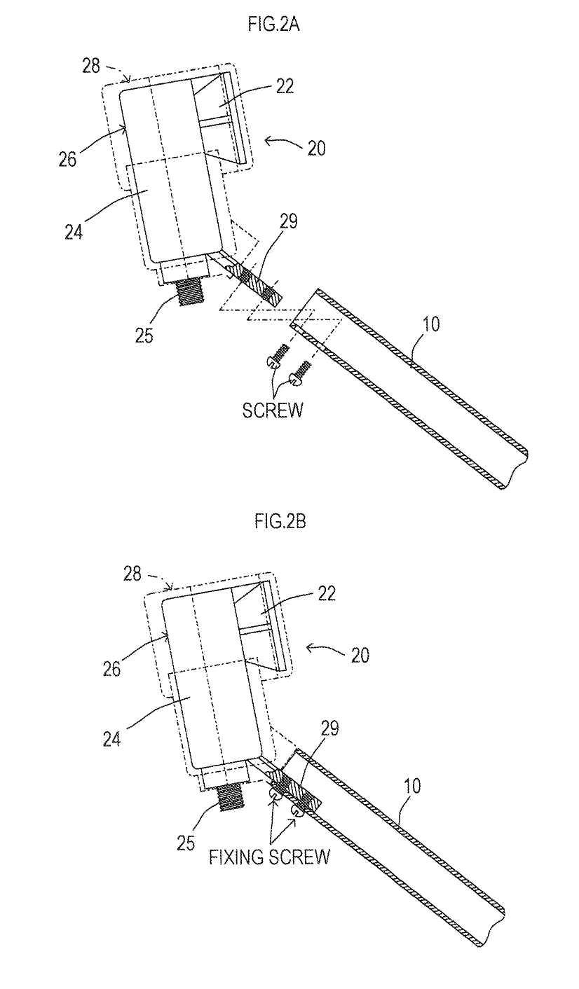

As shown in FIGS. 2A and 2B, the primary radiator 20 includes a body portion 26 made by die-casting. The body portion 26 is configured by integrally forming a horn 22 of the primary radiator 20 and a case portion 24 which houses the converter circuit and others.

The case portion 24 of the body portion 26 is configured to house a receiving section which receives incident electric waves from the horn 22 and a circuit board on which the converter circuit and others are formed. The received signal, whose frequency was converted by the converter circuit, is outputted from an output terminal (F-type connector receptacle) 25 provided in a protruding manner downward from the case portion 24.

The body portion 26 is housed in a synthetic resin case 28 made from synthetic resin. The synthetic resin case 28 protects the body portion 26 so as not to allow rainwater to enter into the case portion 24 from the horn 22.

The supporting arm 10 is configured to be a pipe made from metal. In the body portion 26 of the primary radiator 20, a fixing portion 29 is provided in a protruding manner below the horn 22. The fixing portion 29 is inserted from a tip end of the supporting arm 10 into the pipe to be screwed and fixed from outside.

Thus, by inserting the fixing portion 29 into the supporting arm 10 and fixing the fixing portion 29 by screwing, the primary radiator 20 is firmly fixed to the supporting arm 10, and therefore, to the parabolic reflector 1. Furthermore, an axis line (in other words, a beam central axis of the primary radiator 20) in which reception intensity is maximized within a directional range of the supporting arm 10 is also fixed in a predetermined direction.

Accordingly, a position at which the beam central axis of the primary radiator 20 points at the mirror surface of the parabolic reflector 1 is defined by a position of the tip end of the supporting arm 10 and a protruding angle of the fixing portion 29 in relation to the body portion 26 of the primary radiator 20.

Each of these parameters is determined at the time of designing the offset parabola antenna. In a conventional design method, the following two positions are generally made to be coincident with each other: a position on the mirror surface (i.e., central point of an aperture plane of the parabolic reflector 1) indicated by an axis line passing through a center of the aperture plane when the parabolic reflector 1 is viewed from an arrival direction of electric waves to be collected at the focal point, and the position at which the beam central axis of the primary radiator 20 points at the mirror surface of the parabolic reflector 1. In this case, there is a problem that use efficiency of the parabolic reflector 1 degrades and reception noise due to spillover increases.

Thus, in the present embodiment, characteristics of the primary radiator 20 and a direction of the beam central axis are set as explained below, thereby improving the use efficiency of the parabolic reflector 1 and reducing the spillover. As a result, an antenna gain to noise temperature ratio (G/T) of the offset parabola antenna is improved.

Hereinafter, a method of designing the offset parabola antenna according to the present embodiment will be explained in detail.

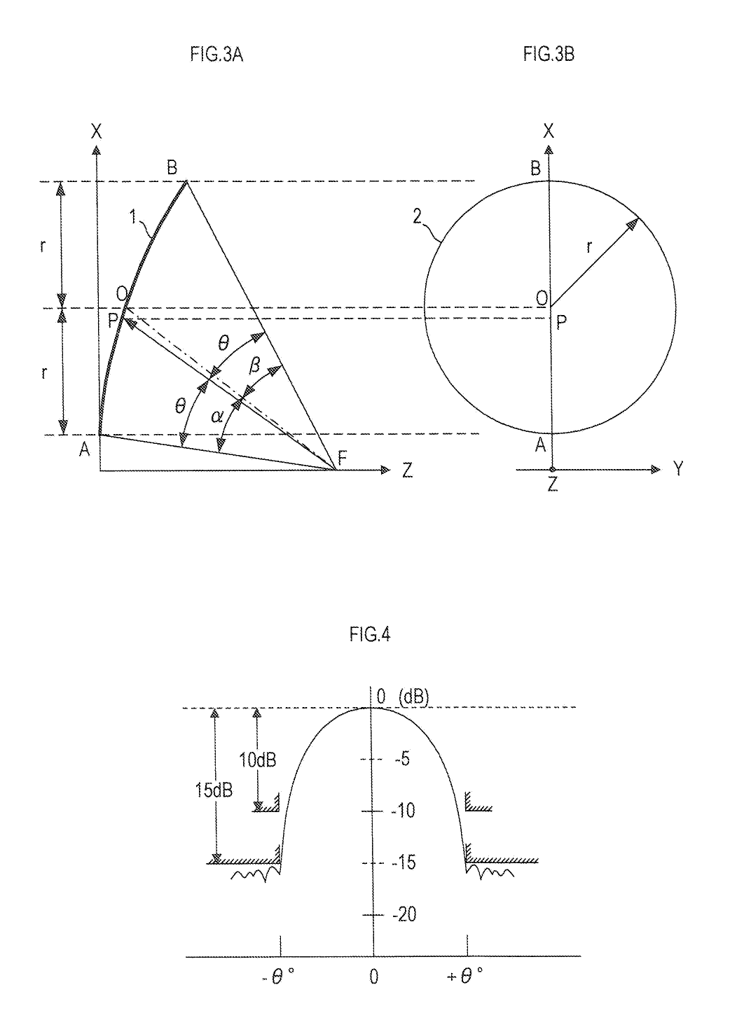

FIGS. 3A and 3B are explanatory views showing a positional relationship between the primary radiator 20 and the parabolic reflector 1 when the primary radiator 20 is fixed to a focal point F of the parabolic reflector 1 in accordance with a normal design method. FIG. 3A is a cross sectional view of the parabolic reflector 1 taken in an XZ plane in a vertical direction passing through a reception point (i.e., the focal point F of the parabolic reflector 1) of the primary radiator. FIG. 3B is a projection view of the parabolic reflector 1 in an XY plane, when viewed from the arrival direction of electric waves to be collected at the focal point F of the parabolic reflector,

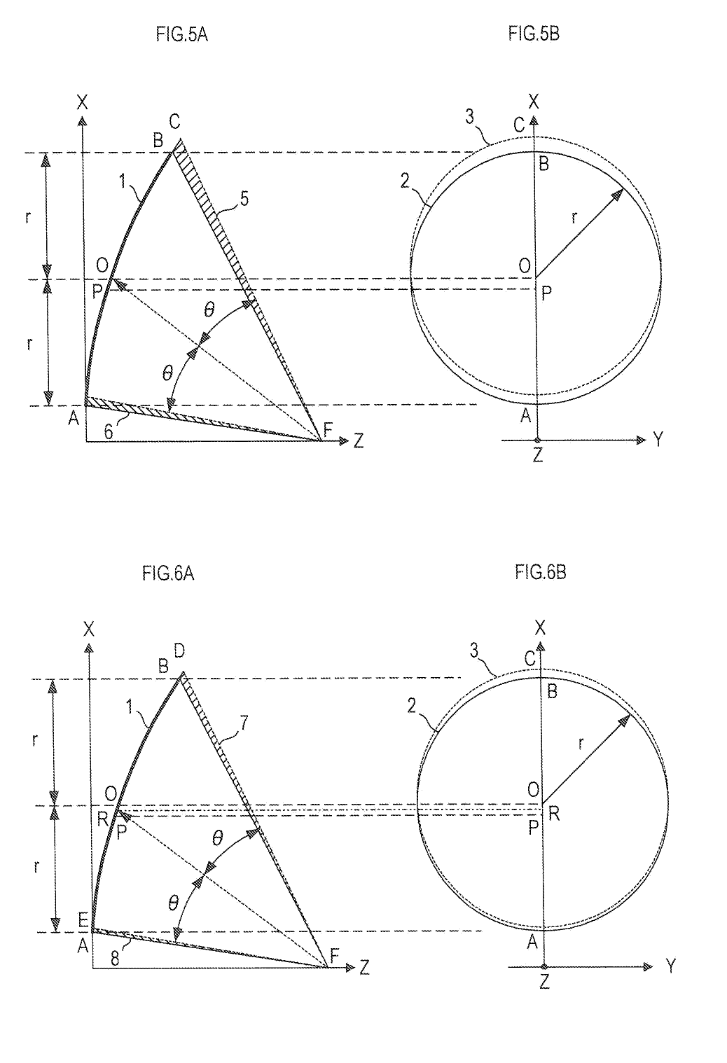

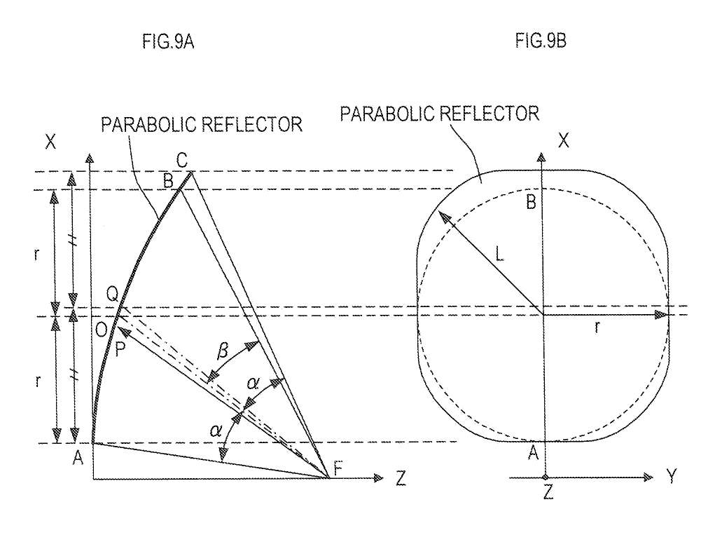

Also, in the above explained FIGS. 8A and 8B, FIGS. 9A and 9B, the later explained FIGS. 5A and 5B, and FIGS. 6A and 6B, (A) and (B) are, respectively, sectional views in the XZ plane as in FIG. 3A and projection views in the XY plane as in FIG. 3B.

As shown in FIG. 3B, the mirror surface of the parabolic reflector 1 in the offset parabola antenna is configured from a portion, offset from a rotational axis of a paraboloid, which is cut out in such a manner that a projection view of an aperture plane has a circular shape with a radius r when viewed from the arrival direction of electric waves to be collected at the focal point F. A point on the mirror surface indicated by an axis line passing through a center of the circle with the radius r is the central point of the aperture plane of the parabolic reflector 1.

In FIG. 3A, reference symbol A indicates a lower edge of the parabolic reflector 1, and reference symbol B indicates an upper edge of the parabolic reflector 1. Also, reference symbol P in FIG. 3A indicates a point on the mirror surface (i.e., a central point of an aperture angle of the parabolic reflector 1) indicated by a bisector (FP) which bisects an angle 28 (i.e., the aperture angle of the parabolic reflector 1) formed by a line BF and a line AF. The line BF is a line connecting the upper edge B of the parabolic reflector 1 and the focal point F. The line AF is a line connecting the lower edge A of the parabolic reflector 1 and the focal point F.

As is understood from FIGS. 3A and 3B, in the parabolic reflector 1 constituting the offset parabola antenna, a position of a central point O of the aperture plane is different from a position of the central point P of the aperture angle. Accordingly, as shown in FIGS. 3A and 3B, in the parabolic reflector 1 which is offset upwards, the central point O of the aperture plane is located above the central point P of the aperture angle.

The difference is several cm in the case of a parabolic reflector with an antenna effective diameter (short-diameter dimension) of 45 cm. However, the amount of the difference may vary depending on an effective diameter or an offset angle of the parabolic reflector 1. The larger the effective diameter or the offset angle becomes, the larger the difference becomes.

At the focal point F of the parabolic reflector 1, the primary radiator 20 is disposed via the supporting arm 10. The primary radiator 20 is generally configured to have the highest sensitivity in relation to electric waves from a central direction in the directional range.

Directional performance of the primary radiator 20 is represented by the directional range and directional characteristics.

The directional range of the primary radiator 20 indicates a range of directivity. In order to efficiently receive reflection waves from the parabolic reflector 1, it is preferably configured that the directional range of the primary radiator 20 is made to be substantially equal to the aperture angle of the parabolic reflector 1.

This is because, if the directional range is greater than the aperture angle, some of electric waves coming from behind the parabolic reflector 1 are directly incident on the primary radiator without being shielded by the parabolic reflector 1, thereby causing reception noise. On the other hand, if the directional range is smaller than the aperture angle, the reflection waves from the parabolic reflector 1 cannot be efficiently received.

For this reason, the directional range of the primary radiator 20 may be set, for example, as an aperture angle BFA (=2θ) of the parabolic reflector 1 shown in FIG. 3A. In the present embodiment as well, the directional range of the primary radiator 20 is set in this way.

The directional characteristics of the primary radiator 20 indicate sharpness of the directivity.

In the present embodiment, in order to inhibit influence of a received electric power received from a vicinity of a border of and outside of the directional range, the directional characteristics are configured such that the received electric power at the border of and the outside of the directional range is smaller by a set value than a maximum received electric power.

That is to say, if an amount of shielding at the border and the outside of the directional range is great, influence by the received noise can be minimized.

In view of the above, in the present embodiment, as illustrated in FIG. 4, the directional range of the primary radiator 20 is set to be in a range which is plus or minus θ from a beam, at which the received electric power is maximized, as the central axis. Thereby, the directional range of the primary radiator 20 is made to be equal to the aperture angle of the parabolic reflector 1. As a result, the directional characteristics of the primary radiator 20 are set such that the received electric power at the border of and the outside of the directional range is lower only by 15 dB than the maximum received electric power.

By constituting as above, it is possible to suppress influences of electric waves directly coming into the primary radiator 20 from the outside of the directional range and electric waves diffracting around a rim of the parabolic reflector 1.

In order to improve gain of the antenna as explained above, the primary radiator 20 with the above described directional performance is generally fixed such that the beam central axis (i.e., the axis line in a position where the received electric power is maximized) of the primary radiator 20 is directed to the central point O of the aperture plane of the parabolic reflector 1.

This state is explained in detail with reference to FIGS. 5A and 5B. FIGS. 5A and 5B are views to explain spillover with a normal parabolic reflector. FIG. 5A is a cross sectional view of the parabolic reflector in the XZ plane. FIG. 5B is a projection view of the parabolic reflector projected onto the XY plane.

In FIGS. 5A and 5B, reference numeral 3 is a projection view indicating the directional range of the primary radiator 20 when viewed from the arrival direction of electric waves, in a case where the primary radiator 20 is disposed such that the beam central axis is directed to the central point O of the aperture plane of the parabolic reflector 1. The projection view has an oval shape with an X-direction dimension longer than a Y-direction dimension.

As is clear from these figures, the primary radiator 20 is configured such that the directional range is made to be equal to the aperture angle BFA of the parabolic reflector 1. Therefore, if the beam central axis is directed to the central point O of the aperture plane while maintaining the size of the directional range of the primary radiator 20, an upper border of the directional range goes beyond the upper edge B of the parabolic reflector 1, thereby generating an extending portion 5 which extends to a point C.

On the other hand, a lower border of the directional range goes upwards beyond the lower edge A of the parabolic reflector 1, thereby generating a portion 6 located inside of the parabolic reflector 1.

That is, when the primary radiator 20 is attached such that the beam central axis of the primary radiator 20 is directed to the central point O of the aperture plane of the parabolic reflector 1, reception gain can be improved. However, since shielding by the parabolic reflector 1 cannot be expected with regard to the extending portion 5, reception noise is increased due to spillover which occurs at the extending portion 5.

For the purpose of more effectively using the reflector, the border of the directional range of the primary radiator 20 may be extended so as to be substantially equal to the lower edge A of the parabolic reflector 1. However, the extending portion 5 extending beyond the upper edge B of the parabolic reflector 1 also further extends, thereby increasing the spillover.

Although noise emanating from the sky is smaller than noise coming from a horizontal direction, etc., generated from the ground and so on, influence of the reception noise generated by the increased spillover is not insignificant.

On the other hand, when the primary radiator 20 is attached such that the beam central axis of the primary radiator 20 is directed to the central point P of the aperture angle of the parabolic reflector 1, the spillover becomes smaller. Thereby, the influence of the reception noise can be reduced. However, improvement of the gain cannot be expected.

In view of the above, the present embodiment focuses not only on improvement of the antenna gain and reduction of the spillover but also on an antenna gain to noise temperature ratio (G/T). Therefore, even in a case of a conventional parabolic reflector, by utilizing the conventional parabolic reflector with maximum efficiency, the present embodiment can provide an offset parabola antenna having an excellent antenna gain to noise temperature ratio (G/T).

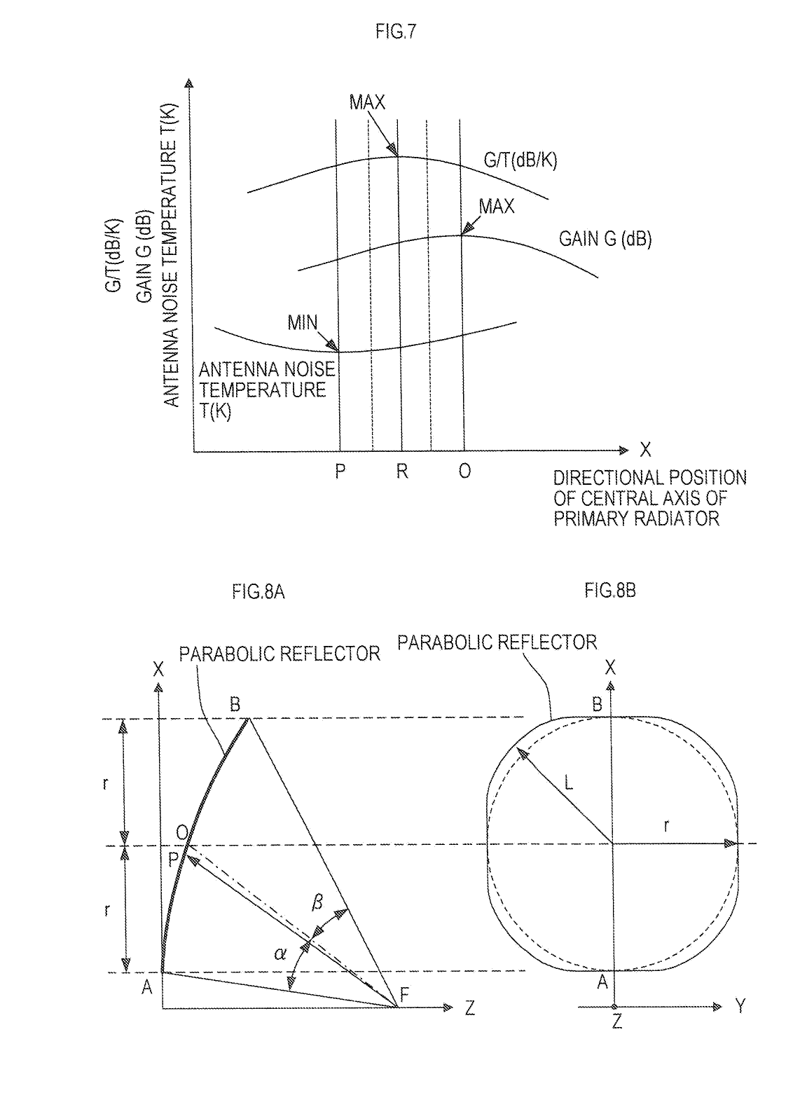

Hereinafter, the above described point is explained in detail with reference to FIGS. 6A, 6B, and 7. FIGS. 6A and 6B are explanatory views showing a positional relationship between the parabolic reflector 1 and the primary radiator 20 according to the present embodiment. FIG. 6A is a cross sectional view of the parabolic reflector 1 in the XZ plane. FIG. 6B is a projection view of the parabolic reflector 1 projected onto the XY plane. FIG. 7 is an explanatory view showing electrical properties of the offset parabola antenna according to the present embodiment.

In the present embodiment, the directional performance of the primary radiator 20 is the same as that shown in FIG. 4. The directional range is 26 which is equal to the aperture angle BFA of the parabolic reflector 1 shown as an example of the embodiment in the present invention. The directional characteristics are configured such that the received electric power at the border of and the outside of the directional range is lower by a set value (for example, 15 dB) than a maximum electric power.

Reference symbol R in FIGS. 6A and 6B is a point indicating a substantially middle position between the central point P of the aperture angle and the central point O of the aperture plane.

This middle position may be a middle point located at a position along the paraboloid of the parabolic reflector 1, or may be a middle point of a line connecting the central point P of the aperture angle and the central point O of the aperture plane.

A feature of the present embodiment is that the beam central axis (the central axis of the directional range or the axis line at the position where the received electric power is maximized) of the primary radiator 20 is directed to an origin of performance to optimize the performance of the antenna. The origin of performance is the above point R.

In FIGS. 6A and 6B, reference numeral 3 shows a projection view indicating the directional range of the primary radiator 20 when viewed from the arrival direction of electric waves in a case where the primary radiator 20 is attached such that the beam central axis of the primary radiator 20 is directed to the origin of performance R of the parabolic reflector 1. The projection view has an oval shape with an X-direction dimension longer than a Y-direction dimension.

In the above state, as shown in FIGS. 6A and 6B, the directional range is made such that an extending portion 7 extending beyond the upper edge B of the parabolic reflector 1 is narrower than the portion 5 shown in FIG. 5A, thereby reducing the spillover. At the same time, a portion 8 located inside of the lower edge A of the parabolic reflector 1 is narrower than the portion 6 shown in FIG. 5A, thereby allowing efficient use of the reflector.

That is, according to the present embodiment, the primary radiator 20 with the above explained directional performance (in other words, directional performance the same as the conventional directional performance) is disposed such that the beam central axis (the axial line at the position where the received electric power is maximized) is directed to the origin of performance R. Thereby, the parabolic reflector 1 can be optimized so as to be utilized as effectively as possible, taking into consideration of the received electric power and the reception noise. Accordingly, an offset parabola antenna having a very excellent antenna gain to noise temperature ratio (G/T) can be provided.

FIG. 7 shows data measured to confirm the above-described effect. The data shows changes in characteristics of various performances of the offset parabola antenna, while a direction, to which the beam central axis of the primary radiator 20 with the above explained directional performance was directed, was moved from the central point P of the aperture angle to the central point O of the aperture plane (or in a reverse direction).

In the present embodiment, the following three were measured as the various performances of the offset parabola antenna: an antenna gain (dB), an antenna noise temperature (K), and an antenna gain to noise temperature ratio (G/T(=dB/K)). The antenna noise temperature (K) indicates a level of noise including unnecessary electric waves of reception noise and spatial noise that may be generated on the ground, in the sky, etc.

According to the data, when the beam central axis of the primary radiator 20 was directed to the central point P of the aperture angle, the reception noise coming from behind the parabolic reflector 1 was shielded by the parabolic reflector 1. Therefore, the antenna noise temperature, among the various performances, showed a substantially minimum value. When the beam central axis of the primary radiator 20 was moved upwards and downwards from the point P as a center, the respective antenna noise temperatures became degraded.

Also, since the beam central axis of the primary radiator 20 was not directed to a direction in which the primary radiator 20 efficiently receives the reflection waves, the antenna gain did not exhibit a maximum value.

Next, when the beam central axis of the primary radiator 20 was gradually tilted upwards from the central point P of the aperture angle to the central point O of the aperture plane, a portion around the outer border of the directional range of the primary radiator 20 gradually extended upwards beyond the upper edge B of the parabolic reflector 1. Therefore, it became impossible to shield some of the reception noise coming from behind the parabolic reflector 1, thereby causing a gradual increase of the antenna noise temperature.

However, since it became possible for the primary radiator 20 to gradually receive the reflection waves with a good efficiency, the antenna gain was gradually improved.

When the beam central axis of the primary radiator 20 was directed to the central point O of the aperture plane, it became possible for the primary radiator 20 to efficiently receive the reflection waves. Thereby, the antenna gain exhibits a substantially maximum value.

When the beam central axis was further directed upwards, the antenna gain was rapidly degraded.

Next, focus is turned to the antenna gain to noise temperature ratio (G/T).

When the beam central axis of the primary radiator 20 was gradually tilted towards the central point O of the aperture plane from the central point P of the aperture angle, it is found that the antenna gain to noise temperature ratio (G/T) was first gradually improved, and thereafter, gradually decreased.

More particularly, it is found that the antenna gain to noise temperature ratio (G/T) exhibited the maximum value when the beam central axis of the primary radiator 20 was directed to a vicinity of the origin of performance R, including the origin of performance R. The origin of performance R was the substantially middle position between the central point P of the aperture angle and the central point O of the aperture plane.

Based on the above experiment results, it is found that when the beam central axis of the primary radiator 20 was directed to the above-explained position, the antenna gain to noise temperature ratio (G/T) was improved by about 0.5 to 1 dB, compared to other conditions.

That is to say, according to the offset parabola antenna of the present embodiment, it is possible to provide a most suitable method to constitute an antenna which allows efficient use of the parabolic reflector 1 by the following configuration: the beam central axis of the primary radiator 20 (specifically, the axial line at the position where the received electric power in the directional range of the primary radiator 20 is maximized (generally, the center of the directional range)) is directed to the origin of performance R; the origin of performance R is the substantially middle position between the central point O of the aperture plane of the parabolic reflector 1 and the central point P of the aperture angle of the parabolic reflector 1. Furthermore, it is also possible to provide an offset parabola antenna having an excellent antenna gain to noise temperature ratio (G/T), with ease and at low cost.

As mentioned above, an optimization method is simple.

Therefore, even in a case of an already-commercialized antenna, by simply directing the beam central axis of the existing primary radiator 20 to the origin of performance R of the parabolic reflector 1 in use, improvement of the antenna gain to noise temperature ratio (G/T) can be achieved. Accordingly, even an existing product can be improved with respect to features of the product, with ease and at low cost.

Furthermore, the offset parabola antenna according to the present embodiment can be configured without changing size and weight from conventional antennas. Thus, without significantly changing usability for users, an offset parabola antenna having an excellent antenna gain to noise temperature ratio (G/T) can be realized. As above, it is possible to provide a highly practical optimization method for the parabolic reflector and the primary radiator 20.

Also, in the offset parabola antenna according to the present embodiment, the directional range is, among the directional performance of the primary radiator 20, configured to be substantially equal to the aperture angle of the parabolic reflector 1. Moreover, the directional characteristics are configured such that the received electric power at the border of and the outside of the directional range is lower by at least a set value than the maximum received electric power, which the primary radiator 20 receives. As above, it is possible to suppress a phenomenon (i.e., spillover) in which some of electric waves coming from behind the parabolic reflector 1 directly incident on the primary radiator 20, thereby reducing the reception noise caused by the spillover. Thus, it is possible to provide an offset parabola antenna having a particularly excellent antenna gain to noise temperature ratio (G/T) which will not be affected by the reception noise.

The present invention should not be limited to the above embodiment. As illustrated below, the present invention can be practiced by appropriately modifying configurations in each portion as long as not departing from the spirit of the present invention.

The directional performance of the primary radiator 20 according to the above embodiment is configured such that the directional range is substantially equal to the aperture angle of the parabolic reflector 1. Moreover, the directional characteristics are configured such that the received electric power at the border of and the outside of the directional range is lower by a set value than the maximum received electric power which the primary radiator 20 receives. Although the set value is preferably set to 15 dB as mentioned above, it may be over 15 dB in part and be in a range of 10 to 15 dB in view of mass productivity.

The above embodiment describes an example of a constitution in which the beam central axis of the primary radiator 20 is directed to the origin of performance R. However, the beam central axis may be directed to, for example, any point within a range of a predetermined size (e.g., circular pattern with a radius of about 5 mm) having the origin of performance R as a center.

By constituting as above, it becomes unnecessary to manufacture parts with high dimensional accuracy and a number of assembling steps can be reduced. Thus, reduction of product costs can be achieved, while maintaining a preferred antenna gain to noise temperature ratio (G/T).

Also, the above embodiment describes that the axial line at the position where the received electric power in a predetermined directional range of the primary radiator 20 is maximized or the beam central axis of the primary radiator 20 is directed to the origin of performance R. The origin of performance R is the substantially middle position between the central point O of the aperture plane of the parabolic reflector 1 and the central point P of the aperture angle of the parabolic reflector 1. However, as the above data indicates, the central point O of the aperture plane may be replaced with “a point at which antenna gain is maximized”, and the central point P of the aperture angle may be replaced with “a point at which an antenna noise temperature is minimized”.

That is, it may be described that the primary radiator 20 is fixed to the supporting arm 10 such that the axial line at the position where the received electric power in the predetermined directional range is directed to the origin of performance R which is a substantially middle position between “a point at which gain is maximized” and “a point at which an antenna noise temperature is minimized”.

Furthermore, the above embodiment is explained in a case of an oval reflector where a projection image of the aperture plane of the parabolic reflector has a circular shape. However, the present invention should not be limited to the above embodiment. For example, as long as an antenna which uses a reflector containing a paraboloid of an offset parabola antenna, an antenna may be one where a projection image of the aperture plane does not have a circular shape.

The above embodiment describes an example corresponding to an offset parabola antenna for receiving satellite broadcasts. However, the present invention should not be limited to this embodiment, and may be applied to an offset parabola antenna for transmission.

Thereby, an antenna having further high efficiency can be provided.

1. An offset parabola antenna comprising:
an elliptical parabolic reflector having a mirror surface in a shape partially cut out from a paraboloid;
a primary radiator; and
a supporting arm which supports the primary radiator to fix the primary radiator at a focal point of the parabolic reflector,
wherein the primary radiator is fixed to the supporting arm such that a beam central axis, at which a received electric power is maximized within a directional range of the primary radiator, is directed to a substantially middle position between a central point of an aperture plane of the parabolic reflector and a central point of an aperture angle of the parabolic reflector, the central point of the aperture plane being a point, on the mirror surface of the parabolic reflector, which is indicated by an axial line passing through a center of the aperture plane when the parabolic reflector is viewed from an arrival direction of electric waves to be collected at the focal point of the parabolic reflector, and the central point of the aperture angle being a point, on the mirror surface of the parabolic reflector, which is indicated by a bisector bisecting an aperture angle formed by two lines respectively connecting both ends of the parabolic reflector in a long-diameter direction and the focal point of the parabolic reflector.

2. The offset parabola antenna according to claim 1,
wherein a directional performance of the primary radiator is configured such that the directional range is substantially equal to the aperture angle of the parabolic reflector, and
directional characteristics are such that a received electric power at a border of and outside of the directional range is lower by a set value than a maximum received electric power within the directional range.
